(19) United States
(12) Patent Application Publication
(10) Pub. No.: US 2026/0104139 A1
(43) Pub. Date: Apr. 16, 2026

(54) Versatile Modular Wall Bracket Mechanism for Supporting various types of containers, or other objects.

(71) Applicant: Austin Anthony Kelly, Dublin (IE)

(72) Inventor: Austin Anthony Kelly, Dublin (IE)

(73) Assignee: Austin Kelly, Dublin (IE)

(21) Appl. No.: 18/914,693

(22) Filed: Oct. 14, 2024

(30) Foreign Application Priority Data
Oct. 13, 2024 (IE) TIE20240000000840
Oct. 13, 2024 (IE) TIE20240000000841

(51) Int. Cl. F16M 13/02

(52) U.S. Cl. CPC F16M 13/022; F16M 13/02

(57) ABSTRACT

The present invention introduces a versatile, modular wall bracket mechanism designed to enhance storage organization by efficiently utilizing vertical wall space. Traditional storage solutions often fall short in versatility, rendering them inflexible for accommodating various items and types of containers, such as storage boxes, especially in environments where maximizing space is crucial. This innovative mechanism addresses these limitations with a customizable support system that facilitates easy attachment, detachment, and reconfiguration of containers and other objects. The main support section, constructed from durable materials like PLA plastic, features adaptable modular components that enable securing to a vertical surface. This design not only optimizes storage configurations but also enhances functional adaptability for home, office, and industrial settings, proving essential for supporting diverse organizational needs.

### BACKGROUND OF THE INVENTION

The present invention relates to modular storage mechanism, specifically related to wall-mounted support systems. Designed to provide a way to support various types containers or other objects. This invention pertains to the field of home and office and industrial organization, allowing for the efficient use of vertical wall space and providing flexibility in storage configurations.

Existing storage solutions, such as shelving units and fixed brackets, often lack the versatility required to accommodate different items that may need to be organized and stored, for example different sizes and types of containers for example, storage boxes. These solutions typically demand either specific containers or can be inflexible in their own functionality to adapt to users changing needs, which can be limiting and inflexible resulting in inefficient use of space, especially in environments where maximizing vertical storage is crucial.

The present invention overcomes these limitations by introducing a versatile, modular wall bracket mechanism system for supporting various container types and other objects. This mechanism provides a customizable support mechanism that can be easily adjusted, reconfigured, or customized to help support various types of containers or other objects, for example, storage boxes, or supporting clothing or items to help support clothes, tools or other items.

The design provides a way to secure the mechanism, by mounting it on a vertical surface, for example, walls, and allows for easy attachment, detachment, and reconfiguration of various types of containers, for example, storage boxes, as well as being able to be configured for use with other items, thereby giving a way to optimize the use of vertical space in a wide range of environments

### PRIOR ART

As I filing as new idea, These is no Prior art related to the design of this mechanism.

### BACKGROUND OF THE INVENTION

At least one specification heading is required. Please delete this heading section if it is not applicable to your application. For more information regarding the headings of the specification, please see MPEP 608.01(a).

### SUMMARY OF THE INVENTION

The invention comprises a modular wall-mounted bracket mechanism that comprises of a main support section made of durable material such as plastic PLA or similar. The main support section can be rectangular, square, or any other shape suitable for supporting various types of containers or other objects, for example, storage boxes or hanging clothes or tools from. The main support section design, incorporates series of holes on one side of its length, designed to receive modular components, and allowing the securing of the main support to a surface and to also allow for the receiving of secondary components. The combination of securing of the main support to a surface coupled with modular components and/or secondary components is what would make up the mechanism to allow it to perform its main function of securing/supporting various types of containers or other objects, for example, storage boxes, to a surface, for example a vertical wall.

### BRIEF DESCRIPTION OF DRAWINGS

FIG. 1 is an is an illustrative of the basic side view of the main parts and their normal arrangement in accordance with embodiments of the present invention.

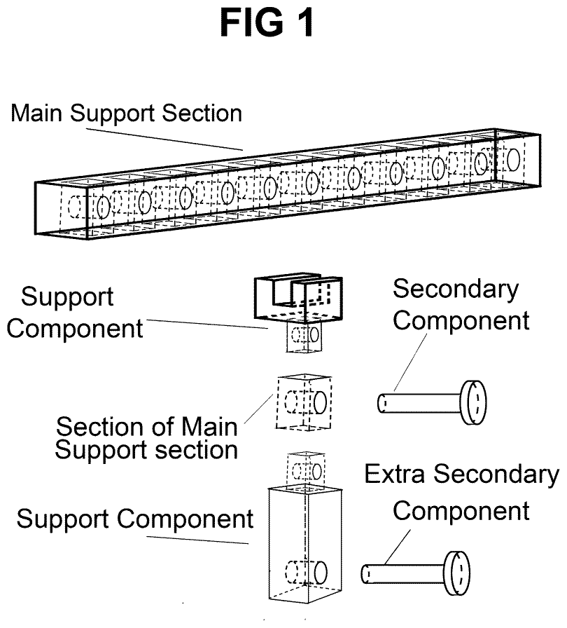

### DETAILED DESCRIPTION OF THE INVENTION

Main Support Section: Material: The main support section is constructed from a strong, durable material, such as plastic PLA, metal, or composite materials, capable of supporting the weight of the different items it could be configured for, for example, a wide variety of containers or other objects, for example, storage boxes.

Shape and Dimensions: The support section can be rectangular, square, or any other practical shape, with a series of holes aligned along at least one side of its length either going straight through or to a certain depth of the main support section, whether they are square, circular, or otherwise shaped, and are designed to receive modular components.

The other side next to it, running parallel to the modular components side, would have at least two holes running along its length, but normally it's a serious of holes, whether they are square, circular, or otherwise shaped that can to be used for securing the main section to a surface, generally a wall, however, they could also be used as a way to secure Secondary components to the main support.

Mounting the Mechanism: As part of the design of the main support section, it can include a way to secure itself to a vertical surface, or use an additional component or components that can be secured to it, that would help provide a way to secure it to a vertical surface. A variety of mounting options, such as screw holes, adhesive backings, or other securing methods can be used to attach it to a vertical surface.

Modular Support Components: Design: The modular components designs may include as part of their design, ledges, brackets, clamps, or other designs that could provide functionality such as, but not limited to, container support, extension components, add decorative designs that provide structure support for the mechanism itself or Specialized components that offer different functionality, which can be inserted into or attached to the main support section. Some of these modular components are designed to provide stable support of various types of containers or other objects, for example, storage boxes, by engaging with their rims, sides, bottom surface, or other structural features. In one embodiment of a modular components, its design, allows for at least one of its functions, a way to extend the length of main support section, by attaching to the main support section, whereby its design may form, or be part of, a part similar to that of the main support section, but may vary in size, although it can be of a different design that could be considered an extension of the main support or provide a way to couple the main support section to another part. For example, its design would slide into any holes available on the main support section.

In one embodiment of a modular support component, it could use any number of any holes on the main support section to act as a anchor for its own design.

In an embodiment of a design of a Modular Support component, may have them protrude through the bottom of the main support sections modular support components entry holes. Some Modular Support components design can be secured to the main support section by sliding over or clipping onto the sides of the main support section. These methods ensure the components remain in place while allowing for easy reconfiguration.

Customizable Configurations: Users can insert or attach the Modular Support components at various positions along the main support section, providing flexibility in supporting items, like different sizes and types of containers or other objects, for example, storage boxes. The modular design allows for easy addition, removal, or repositioning of these components to accommodate changing storage needs.

Secondary Components: Design: The secondary components designs may include as part of their design, ledges, brackets, clamps, Extended rods/pegs/pins, or other designs that could provide functionality such as, but not limited to, container support, extension components, add decorative designs, providing an anchor point for its design. They could form, or be attached to, another component or design that offer different functionality, which would be attached in some way to the main support section. Some of these secondary components are designed to provide stable support of various types of containers or other objects, for example, storage boxes, by engaging with their rims, sides, bottom surface, or other structural features. In an embodiment of one of these secondary components, at least one of their functions is to provide a way to extend the main support section, by attaching to the main section though any of the holes on the main support section. Another secondary component's design could be a face plate, or another being an extension pin/peg.

In one embodiment of a secondary component, its design, allows for, at least one of its functions, is to provide a way to extend the length of main support section, by attaching to the main support section whereby its own design may form, or be part of, a similar design to that of the main support section, although it can be of a different design that could be considered an extension of the main support. In one embodiment of a secondary component, it could use any number of any holes on the main support section to act as a anchor for its own design.

Customizable Configurations: Users can insert or attach the secondary components at various positions along the main support section, providing flexibility. The modular design allows for easy addition, removal, or repositioning of these components to accommodate the configuration of the mechanism.

Attachment Mechanisms: Both Modular Support components and Secondary components can be secured to the main support section using a variety of methods, whether this be as part of their design, or/and through the use of any additional components including but not limited to pegs, snap-fits, magnetic attachments, screws, bolts, Pins, rods, fixings, clips, push-fit, slide-fit, friction-fit, or any other suitable method whether it is through any holes or shapes on the main support section, or used in combination with any holes or shapes or features on the main support section. Some secondary components designs can be secured to the main support section by sliding over or clipping onto the sides of the main support section. These methods ensure the components remain in place.

Additional fixing locations: Another location that a could be used to allow for the use of either Modular Support Components or secondary components, or other complementary components is the vertical outside end walls either end of the main support section, that could be used, either by the way it is designed, or adapted, to allow for, the securing of said components, to the main support structure, such as but not limited to, a faceplate, Structural holding/anchoring component, parts that would provide extension functionality, parts that would provide extra functionality.

1. Versatile Modular Wall Bracket Mechanism for Supporting various types of containers, or other objects which comprises:
a main support section made from a durable material, featuring a series of holes designed to receive either modular support components and/or secondary components which makes up the mechanism;
a plurality of both modular support components and secondary components, each designed to be able to be connected to, the said main support section, or extensions of the main support section, or each other, to provide various mechanisms or function/s, mainly for, but not limited to, the support of Containers or other items, such as plastic storage boxes, or other types of containers, wherein the components are secured to the main support section, or each other then to the main support section, by using a variety of attachment mechanisms or methods.

2. The Versatile Modular Wall Bracket System of claim 1, wherein the main support section and any other of its parts, is constructed from materials of a suitable material, who's properties can perform the intention of the design of each part.

3. The Versatile Modular Wall Bracket System of claim 1, wherein any of its modular components include a design that allows for the support of various items, for example containers, such as storage boxes, thereby providing a stable support mechanism.

4. The Versatile Modular Wall Bracket System of claim 1, wherein the main support section includes holes of various shapes, including square, circular, and hexagonal, to accommodate different types of components that provide support or other functions.

5. The Versatile Modular Wall Bracket System of claim 1, wherein the modular components include designs that form clamps, brackets, or other mechanisms designed to engage with structural features of storage boxes such as their rims and/or other structural features.

6. The Versatile Modular Wall Bracket System of claim 1, wherein the support components can be reconfigured along the length of the main support section to accommodate different storage box sizes, brands, and configurations.

7. The Versatile Modular Wall Bracket System of claim 1, wherein the main support section allows for, either by itself, or with the use of its components, at least one mounting option for attachment to a vertical surface, including screw holes, adhesive backing, and other suitable methods.

8. The Versatile Modular Wall Bracket System of claim 1, wherein its components are interchangeable and can be used with any main support section of the same or compatible design, providing a universally adaptable storage solution.
